(19) United States
(12) Patent Application Publication
(10) Pub. No.: US 2004/0123630 A1
(43) Pub. Date: Jul. 1, 2004

(54) Preform fabrication process

(76) Inventor: Arnab Sarkar, West Hills, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/333,645

(22) PCT Filed: Jul. 17, 2001
(86) PCT No.: PCT/US01/22475

(51) Int. Cl. C03B 37/018

(52) U.S. Cl. 65/421

(57) ABSTRACT

A process is disclosed for making a cylindrical glass preform by outside vapor deposition. Initially, a glass soot stream is directed from a deposition burner to a tapered mandrel, as the mandrel rotates about its longitudinal axis and as the burner reciprocates longitudinally along the mandrel. Mounted at opposite ends of the mandrel are a tubular glass handle and a glass tube having a closed end. After deposition has been completed, the mandrel is removed, leaving a porous glass preform with a central aperture and with the glass handle and the glass tube located at its opposite ends. The porous preform then is dehydrated and sintered into a dense glass preform, which is placed in an elongation machine that heats the end of the preform carrying the closed glass tube, while a vacuum is drawn from the central aperture via the handle. This collapses the aperture and elongates the preform into a solid glass rod.

### BACKGROUND OF THE INVENTION

This invention relates generally to the fabrication of optical fiber preforms by chemical vapor deposition or flame hydrolysis, and, more particularly, to the fabrication of optical fiber preforms using outside vapor deposition.

Four processes for fabricating optical fiber preforms are currently in commercial use, namely, modified chemical vapor deposition (MCVD), plasma chemical vapor deposition (PCVD), outside vapor deposition (OVD), and vapor axial deposition (VAD). The OVD process is a form of chemical vapor deposition processes called flame hydrolysis, in which a reactant in the form of a halide, non-halide organometallic compound, or a hydride of a glass-forming material in vapor form, is fed into an oxy-hydrogen or oxy-gas flame. The resulting reaction between the reactant and water produced in the flame produces sub-micron particles of glass called soot. This soot collects on a deposition surface, in which the dominant mechanism is thermophoresis. This flame hydrolysis process is described in U.S. Pat. No. 2,272,342 to Hyde.

The basic OVD process is described in U.S. Pat. No. 3,737,292 to Keck et al. (reissued as U.S. Pat. No. Re 28,029). First, the soot of the core glass is deposited onto a cylindrical mandrel, and then the soot of the clad glass is deposited onto the previously deposited core glass. After deposition has been completed, the mandrel is removed and the cylindrically shaped porous soot preform is sintered into a dense glass from which optical fiber can be produced. Subsequent patents in the field are directed to specific steps of this process.

One particularly difficult aspect of the OVD process is the removal of the mandrel from the cylindrically shaped soot preform without damaging the preform's inner surface. This is important because that inner surface ultimately will form the central axis of the optical fiber's core. U.S. Pat. No. 3,775,075 to Keck et al. discloses an attempt to eliminate mandrel removal altogether, by depositing the soot onto an integral tube mandrel that will become a part of the optical fiber. U.S. Pat. No. 4,233,052 to Dominick et al. teaches the application of a carbon coating to the mandrel, to enable the mandrel to be removed without damaging the preform's inner surface. Further, U.S. Pat. No. 4,486,212 to Berkey teaches a deposition process control to eliminate devitrification of the preform's inner surface, which contacts the carbon-coated mandrel.

Another aspect of the process is the depositing of soot onto the mandrel in such a manner that, after removal of the mandrel, the porous cylindrical soot preform is convenient to handle. U.S. Pat. No. 4,289,517 to Bailey et al. teaches the insertion of an integral glass handle onto one end of the mandrel. After removal of the mandrel, this integral glass handle remains attached to the porous soot preform, for use as a handle for the preform during subsequent processing.

Another aspect of the process is the independent control of the diameter of the cylindrical soot preform and the ratio of the diameters of the preform's core glass and clad glass. U.S. Pat. No. 3,932,162 to Blankenship teaches elongating the sintered preform to reduce its cross-section, a process step that can be referred to as “rod-draw,” and adding additional glass by sleeving a glass tube of desired cross-section over the preform. Further, U.S. Pat. No. 4,257,797 to Andrejco et al. teaches an alternative way of adding glass to the preform, by depositing and sintering additional glass by the OVD process.

Another aspect of the process is the closing of the preform's central aperture after the mandrel has been removed, to form a solid glass rod or fiber, without fracturing or otherwise damaging the preform. This has been accomplished in the past using several different techniques. U.S. Pat. No. 4,344,670 to Blankenship teaches applying a compressive inner layer to the soot preform. U.S. Pat. No. 4,358,181 to Gulati et al. teaches stress balancing between the core and clad compositions. U.S. Pat. No. 4,413,882 to Bailey et al. teaches a step of collapsing the central aperture of the porous soot preform during sintering into a dense glass. U.S. Pat. No. 4,453,961 to Berkey, and its division U.S. Pat. No. 4,784,465, teaches the collapsing of the central aperture under vacuum during elongation or rod-draw of the preform, and also the fabrication of a tubular preform having both of its ends closed, to enclose the tube's aperture.

More particularly, U.S. Pat. No. 4,453,961 (“the Berkey '961 patent) teaches an OVD process having specific process steps that carry out many of the earlier-developed improvements. FIG. 1 of the patent is a schematic diagram of structure for performing the first step of the OVD process, the structure including end burners for increasing the density of the soot at the ends and thereby preventing breakage. The end burner located at the tip end of the soot preform, opposite the integral handle, functions to increase the force of adhesion between the heated section of the soot and the mandrel. If an end burner is not used at the tip end, or if the heat provided at the tip end is inadequate, a crack can be initiated at that end. On the other hand, if the heat supplied by the end burner at the tip end is excessive, removal of the mandrel will be difficult without damaging the soot preform's inner surface.

After the mandrel has been removed from the porous soot preform, in a process step requiring operator intervention, the preform is heated to form an elongated, consolidated glass preform having a central, longitudinal aperture along its length. Such a consolidated glass preform is depicted in FIG. 2 of the Berkey '961 patent.

In a separate process step described in the Berkey '961 patent, the tip end of the consolidated glass preform is closed using a glass lathe. The central aperture then is evacuated from the handle end and the evacuated aperture is sealed under vacuum. Such a preform is depicted in FIG. 3 of the patent. This preform then is elongated in a furnace, to reduce its diameter and simultaneously to close the aperture and form a solid glass rod. Additional glass can be deposited onto this solid glass rod, to form the final preform.

It should be appreciated from the foregoing description that there is a need for an improved OVD process for fabricating a soot preform that requires fewer process steps and that requires less manual intervention. The process of the present invention satisfies these needs and provides further related advantages.

### SUMMARY OF THE INVENTION

The present invention resides in a simplified process for making a cylindrical glass preform by outside vapor deposition, requiring fewer processing step and less manual intervention than previous similar processes. In the process, a tapered mandrel is provided, and a tubular handle is placed at one end of the mandrel and a tubular tip having a closed end is placed at the other end of the mandrel. A soot stream is directed at the mandrel while the mandrel rotates about its longitudinal axis and reciprocates longitudinally relative to the soot stream. This forms a cylindrical soot preform extending from the tubular handle to the tubular tip. After the preform has been formed, the mandrel is removed, leaving a central aperture extending from the tubular handle to the tubular tip. The cylindrical soot preform then is dehydrated and sintered into a dense glass preform and, finally, the dense glass preform is elongated while drawing a vacuum from the aperture via the tubular handle, to collapse the aperture and simultaneously reduce the preform's cross-sectional size.

In more detailed features of the invention, the deposition burner and the mandrel are moved longitudinally relative to each other such that direction reversals occur when the soot stream reaches the tubular handle and when the soot stream reaches the tubular tip. The soot deposited in the regions of the tubular handle and the tubular tip are heated, to prevent cracking and flaking of the soot and to increase adherence of the soot on the glass surface. The soot stream can be formed by flame hydrolysis using an oxy-gas or oxy-hydrogen flame.

In other more detailed features of the invention, the tapered mandrel comprises alumina, and the tubular handle and tubular tip comprise silica glass. Further, before the soot is deposited onto the mandrel, a carbon coating can be deposited onto the mandrel, extending from the tubular handle to the tubular tip.

Other features and advantages of the present invention should become apparent from the following description of the preferred process, taken in conjunction with the accompanying drawings, which illustrate, by way of example, the principles of the invention.

### BRIEF DESCRIPTION OF THE DRAWINGS

FIG. 1 is a schematic side view of a prior art apparatus for depositing a porous soot preform onto a tapered mandrel, using a burner that reciprocates longitudinally along the mandrel while the mandrel rotates about its longitudinal axis.

FIG. 2 is a schematic side view of the porous soot preform of FIG. 1, after it has been removed from the tapered mandrel, with a tubular glass handle projecting from one end of the preform and with a central aperture extending along the length of the preform where the mandrel had been located.

FIG. 3 is a schematic side view of the porous glass soot preform of FIG. 2, after the tubular handle has been crimped and after the tip end of the preform opposite the handle has been closed, to close off the preform's evacuated central aperture.

FIG. 4 is a schematic side view of apparatus for carrying out the method of the invention, the apparatus depositing a porous soot preform onto a tapered mandrel, using a burner that reciprocates longitudinally along the mandrel while the mandrel rotates about its longitudinal axis, with a tubular glass handle located at one end of the mandrel and a glass tube having a closed end located at the other end of the mandrel.

FIG. 5 is a schematic side view of the porous soot preform of FIG. 4, after it has been removed from the tapered mandrel and sintered into a dense glass preform having a central aperture, with the tubular glass handle projecting from one end, and with the glass tube having a closed end projecting from the other end.

FIG. 6 is a schematic side view of an elongation machine for collapsing the central aperture of the porous glass preform of FIG. 5 and elongating the preform into a solid glass rod, wherein the preform's open end is connected via a conduit to a vacuum pump and the preform's closed end is heated by a furnace.

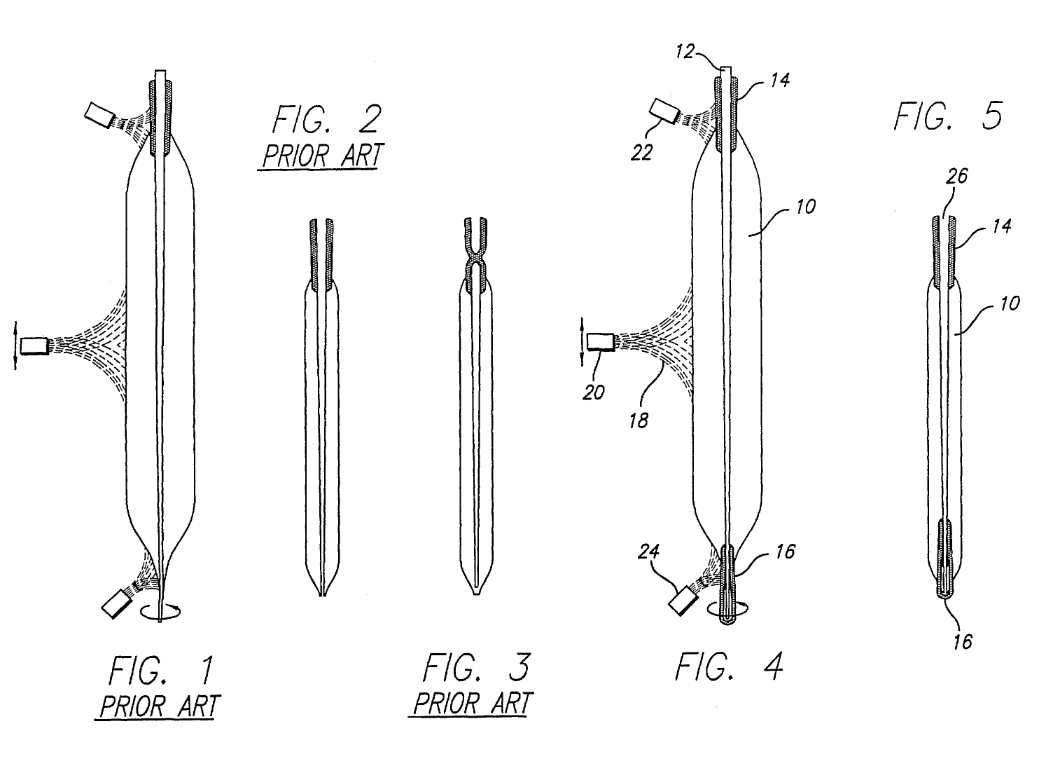

### DESCRIPTION OF THE PREFERRED PROCESS

With reference now to the illustrative drawings, and particularly to FIGS. 4-6, there is shown apparatus that can be used in a process for making a solid glass rod useful in the production of optical fibers. FIG. 4 illustrates a portion of a deposition machine, for implementing the initial steps of the process, in which a porous cylindrical preform 10 is formed by outside vapor deposition (OVD). A tapered mandrel 12 is mounted on a chuck (not shown) of the deposition machine. The mandrel is formed of any conventional material, e.g., alumina, having the desired purity and taper. A tubular silica glass handle 14 is slid onto the mandrel's proximal end, coaxial with the mandrel. This handle, which can be similar to the one disclosed in U.S. Pat. No. 4,289,517 to Bailey et al., is useful for handling the deposited preform after the mandrel has been removed.

Further, a silica glass tube 16 having a closed distal end is mounted onto the mandrel's distal end. Conveniently, this tube can be mounted onto the mandrel 12 by securing the tube's closed end to a second chuck (not shown) of the deposition machine, the second chuck having a rotation axis aligned with that of the first chuck. After the glass tube has been secured to the second chuck, the two chucks are moved toward each other until the mandrel has been slid firmly into the glass tube's open end. The second chuck is then locked in place, and the mounted assembly is rotated around a common axis.

As is conventional, a layer of carbon can be applied to the outer surface of the mandrel 12, to facilitate removal of the mandrel from the preform 10 after deposition of the preform has been completed. To position the mandrel along the rotation axis, shims (not shown) of a suitable material can optionally be positioned between the mandrel and the glass handle 14 and between the mandrel and the glass tube 16.

Glass soot is deposited onto the mandrel 12 by directing a soot stream 18 from a burner 20 while the mandrel rotates about its longitudinal axis and oscillates longitudinally relative to the burner. The burner is a flame hydrolysis burner with an oxy-gas or an oxy-hydrogen flame, which is fed with vapors of appropriate glass-forming oxide precursors. As the burner traverses along the length of the mandrel, glass of desired composition and cross-section is deposited onto the length of the preform. Over time, this forms a porous soot preform 10 having a generally cylindrical shape.

The successive reversals of the longitudinal movement of the mandrel 12 relative to the burner 20 occur when the soot stream is being directed at the glass handle 14 and at the glass tube 16. The ends of the mandrel and preform 10 are heated using end-burners 22 and 24. This prevent cracking and flaking of the preform, and it increases adherence of the soot on the glass surface. The end burners are not positioned to heat any portions of the soot deposited directly onto the mandrel.

After the deposition of the porous glass preform 10 has been completed, the deposited preform is removed from the deposition machine and allowed to cool to room temperature. As the preform cools, differential thermal contraction reduces the cross-section of the alumina mandrel 12 relative to the inner surface of the deposited glass. This contraction, coupled with the mandrel's taper, allows the mandrel to be pulled out from the deposited glass preform, leaving the preform attached to the glass handle 14 at one end and to the glass tube 16 at the other end. The preform then can be dehydrated and consolidated by sintering into a clear glass. The resulting glass preform, shown in FIG. 5, has an aperture 26 extending along its centerline, where the mandrel previously had been located. This aperture is open at its proximal end, but closed at its distal end, because of the presence of the glass tube.

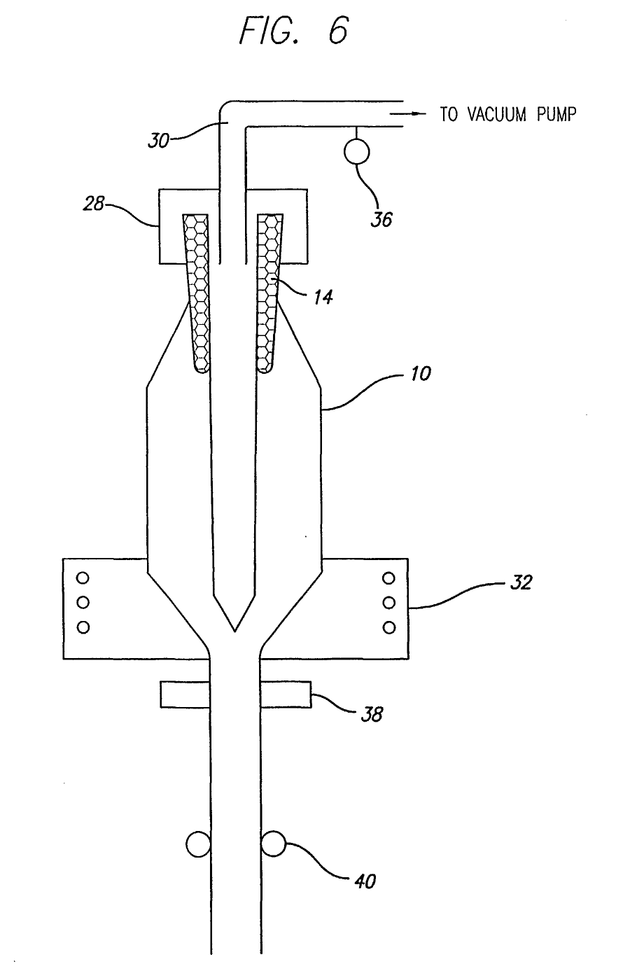

In the next step of the process, illustrated in FIG. 6, the porous soot preform 10, with one end closed and the other end still open, is mounted in a chuck 28 of an elongation machine, for elongation into a solid glass rod. Specifically, the preform's open end is connected via a conduit 30 to a vacuum pump (not shown), and the closed end is heated by a furnace 32. During this elongation process, the diameter of the preform is reduced and, simultaneously, the aperture 26 is closed. This forms a solid glass rod 34. Throughout the process, a pressure gauge 36 monitors the level of vacuum within the aperture, and a diameter gauge 38 and set of pinch rollers 40 monitor and control the diameter of the solid glass rod. From this point on, the process steps can correspond to those described in U.S. Pat. No. 4,453,961 to Berkey.

Additional glass can subsequently be added to the solid rod, to form the final preform. For example, a glass cladding can be deposited onto the rod, as by an OVD process, and the deposited cladding then can be sintered to yield the final preform.

In the process described above, the inner surface of the glass preform 10, i.e., the surface adjacent to the aperture 26, need not be etched or washed. This simplification thus improves on the process described in U.S. Pat. No. 4,453,961. Alternatively, if dehydration or cleaning of the inner surface of the consolidated preform is required prior to the elongation process, e g., to obtain low-loss, low-water fiber using this process, the surface can be dry etched in the presence of a fluorine-containing gas, e.g., sulphurhexafluoride, in a glass lathe.

Devitrification of the surface adjacent to the central aperture 26 can be avoided by using uniform deposition on a mandrel that does not cause devitrification of the layer adjacent to it. This improves on the approach described in U.S. Pat. No. 4,486,212 to Berkey, in which devitrification is avoided by reducing the deposition rate. The process according to this invention thus yields a solid glass rod with a reduced number of process steps. In addition, the step of removing the mandrel from the porous glass preform is accomplished relatively easily as compared to prior processes.

It is to be noted that the drawings are illustrative and symbolic of the invention, and they are not intended to indicate scale or relative proportions of the depicted elements. Further, it is to be noted that the present invention expressly contemplates both single-mode and multi-mode fibers, regardless of any specific description, drawing or example set forth.

Although the invention has been described with reference only to the preferred process, those skilled in the art will appreciate that various modifications can be made to the process without departing from the invention. Accordingly, the invention is defined only by the following claims.

I claim:

1. A process for making a cylindrical glass preform by outside vapor deposition, comprising:
providing a tapered mandrel that defines a longitudinal axis;
placing a tubular handle at one end of the mandrel and a tubular tip having a closed end at the other end of the mandrel;
directing a soot stream at the mandrel while the mandrel rotates about its longitudinal axis and reciprocates longitudinally relative to the soot stream, to form a cylindrical soot preform extending from the tubular handle to the tubular tip;
removing the mandrel from the cylindrical soot preform, such that the preform has a central aperture extending from the tubular handle to the tubular tip;
dehydrating and sintering the porous preform into a dense glass preform having a central aperture extending from the tubular handle to the tubular tip; and
elongating the dense glass preform, while drawing a vacuum from the aperture via the tubular handle, to collapse the aperture and simultaneously reduce the preform's cross-sectional size.

2. A process as defined in claim 1, wherein:
the tapered mandrel provided in the step of providing comprises alumina; and
the tubular handle and the tubular tip placed in the step of placing comprises silica glass.

3. A process as defined in claim 2, and further comprising depositing a carbon coating onto the mandrel, extending from the tubular handle to the tubular tip, prior to directing a soot stream at the mandrel.

4. A process as defined in claim 1, wherein directing a soot stream at the mandrel includes reversing the direction of the relative longitudinal movement of the mandrel relative to the soot stream when the soot stream reaches the tubular handle and when the soot stream reaches the tubular tip.

5. A process as defined in claim 1, and further comprising heating the soot deposited in the regions of the tubular handle and the tubular tip.

6. A process as defined in claim 1, wherein the soot stream directed in the step of directing is formed by flame hydrolysis using an oxy-gas or oxy-hydrogen flame.
